(19) United States
(12) Patent Application Publication
(10) Pub. No.: US 2010/0290075 A1
(43) Pub. Date: Nov. 18, 2010

(54) DOCUMENT MANAGING SYSTEM AND DOCUMENT MANAGING METHOD

(75) Inventors: Kazuhiro Ogura, Kanagawa-ken (JP); Toshihiro Ida, Shizuoka-ken (JP); Akihiko Fujiwara, Kanagawa-ken (JP); Hajime Tomizawa, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/767,930

(22) Filed: Apr. 27, 2010

Related U.S. Application Data
(60) Provisional application No. 61/178,194, filed on May 14, 2009.

(30) Foreign Application Priority Data
Mar. 25, 2010 (JP) 2010-069020

(51) Int. Cl. G06F 15/00

(52) U.S. Cl. 358/1.14; 358/1.15

(57) ABSTRACT

According to one embodiment, a document managing system includes a user authentication unit configured to acquire user information of a user, a read unit configured to read a manuscript and read manuscript trace information given to the manuscript, a determination unit configured to determine, in case of copying the manuscript, whether the user is authorized to copy the manuscript based on the user information read in the user authentication unit and the manuscript trace information, and an image output unit configured to, if the determination unit determines that the user is authorized to copy, output an image including new trace information readable in a read unit along with the manuscript read in the read unit.

### CROSS-REFERENCE TO RELATED APPLICATION

This application is based upon and claims the benefit of priority from the prior U.S. patent application No. 61/178194, filed on May 14, 2009, the entire contents of which are incorporated herein by reference.

This application is also based upon and claims the benefit of priority from Japanese Patent Application No. 2010-69020, filed on Mar. 25, 2010, the entire contents of which are incorporated herein by reference.

### TECHNICAL FIELD

Exemplary embodiments described herein relate to a document managing system and a document managing method.

### BACKGROUND

A manager can manage computerized files in terms of trace information as to, for example, who has accessed. However, once the computerized files have been printed, they can be easily copied, which makes their management difficult. JP-A 2009-105529 discloses a technique capable of copying a manuscript printed on sheet mediums only when some conditions are met for lifting a ban on the duplication of the manuscript. However, the technique has a problem in that where the copied manuscripts are distributed cannot be traced.

### BRIEF DESCRIPTION OF THE DRAWINGS

FIG. 1 is a block diagram showing an MFP according to a first embodiment;

FIG. 2 is a flowchart for explaining operations of a processor according to the first embodiment;

FIG. 3 is a diagram showing a distribution destination selection screen;

FIG. 4 is a diagram for explaining an image of a ledger to be printed;

FIG. 5 is a flowchart for explaining a detailed scan operation according to the first embodiment;

FIG. 6 is a flowchart for explaining a detailed copy operation added with a new QR code;

FIG. 7 is a block diagram for entirely explaining a second embodiment;

FIG. 8 is a block diagram showing an MFP according to the second embodiment;

FIG. 9 is a block diagram showing a server according to the second embodiment;

FIG. 10 is a flowchart for explaining a detailed scan operation according to the second embodiment; and

FIG. 11 is a flowchart for explaining a server operation according to the second embodiment.

### DETAILED DESCRIPTION

An aspect of the present disclosure relates to a document managing system, containing: a user authentication unit configured to acquire user information of a user; a read unit configured to read a manuscript and read manuscript trace information given to the manuscript; a determination unit configured to determine, in case of copying the manuscript, whether the user is authorized to copy the manuscript based on the user information read in the user authentication unit and the manuscript trace information; and an image output unit configured to, if the determination unit determines that the user is authorized to copy, output an image including new trace information readable in a read unit along with the manuscript read in the read unit.

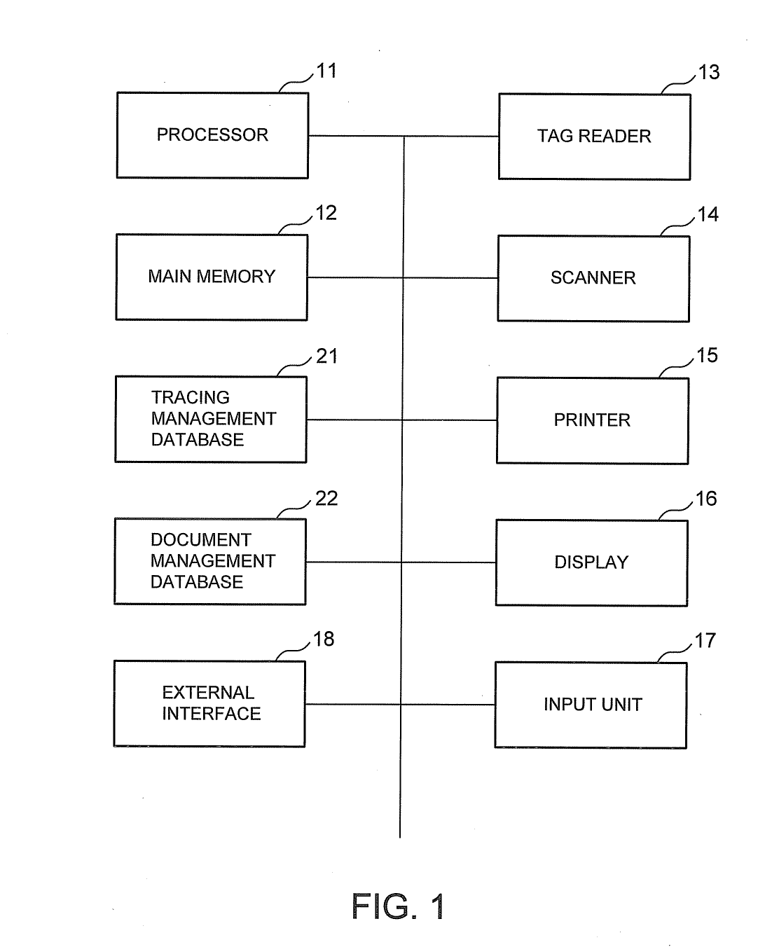

A first embodiment will be described with reference to FIGS. 1 to 6. FIG. 1 is a block diagram of an MFP (Multi Function Peripheral) as a document managing system.

In the present embodiment, an example in which part of the MFP 1 serves as a server function will be described.

The MFP 1 includes a processor 11 for controlling the operations of an entire apparatus and a main memory 12. The main memory 12 includes a memory for storing therein control programs of the apparatus and a memory for temporarily storing therein data when various operations are executed. Further, the MFP 1 includes a tag reader 13 for reading user authentication information, a scanner 14 for reading a manuscript on sheets and the like, and a printer 15 for outputting an image of the manuscript read in the scanner 14 as copied sheets.

The scanner 14 includes a well-known CCD (Charge Coupled Device) image sensor and may contain any of a monochrome reader and a color reader therein. The scanner 14 includes an automatic manuscript feeding apparatus for continuously reading multiple manuscripts. The printer 15 may be a well-known printer such as electrophotographic printer or inkjet printer and may be of any recording system. The MFP 1 further includes a display 16 including a display device for displaying copy information, and an input unit 17 including an input panel for inputting the number of volumes of copy. The input panel may be a touch panel integral with the display device.

The MFP 1 includes an external interface 18 for receiving data from the outside and transmitting the data to the outside. Further, the MFP 1 includes a tracing management database (tracing management DB) 21 for storing therein information for managing the traces of the copied manuscript, and a document management database (document management DB) 22 for managing the documents. The tracing management DB 21 and the document management DB 22 may be integrally provided.

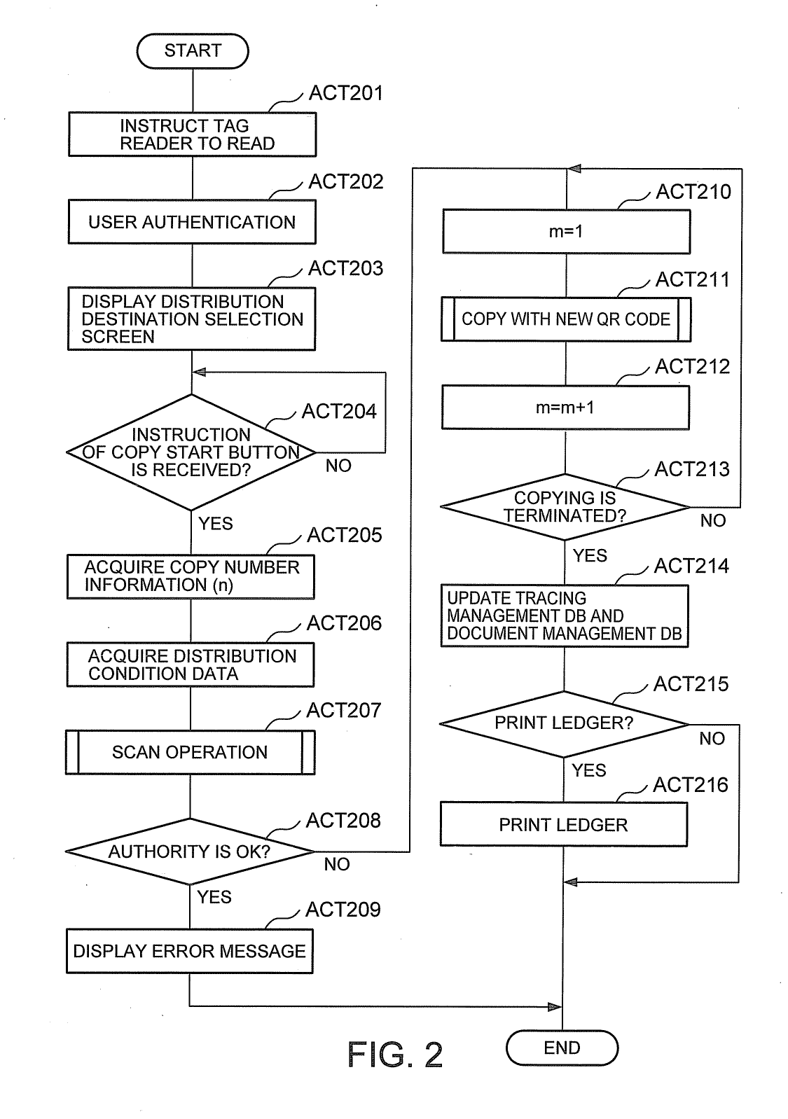

Next, the copy operation according to the present embodiment will be described using the flowchart of FIG. 2.

The processor 11 issues a read instruction as to whether a tag is present in a tag reader readable area of the tag reader 13 (ACT 201). The processor 11 performs authentication on a user near the MFP 1 based on the information from the tag reader (ACT 202). The processor 11 acquires information such as user name and user's given authority upon the user authentication. The processor 11 issues an instruction of displaying a distribution destination selection screen on the display 16 based on the user's given authority (ACT 203).

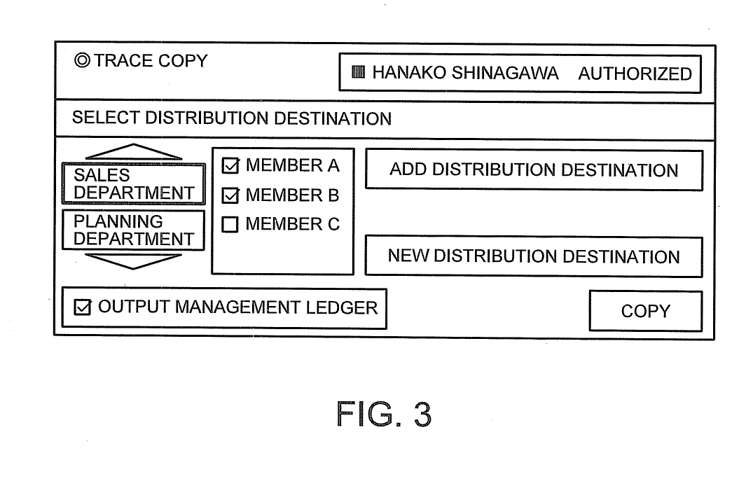

There will be described in FIG. 3 the distribution destination selection screen displayed on the display 16 based on the display instruction of the processor 11. There is displayed at the upper left of the screen that the present mode is the trace copy mode. The name of a present copy operator is displayed at the upper right of the screen. The name of a distribution destination organization is displayed on the left at the center of the screen. In this example, a sales department and a planning department are candidates, the members' names of the sales department are displayed at the center, and the distribution destination targets are marked. A distribution destination addition button and a new distribution destination button are displayed on the right at the center. A management ledger output button is displayed at the lower left of the screen. A copy button is displayed at the lower right of the screen and the copy button is pressed at the start of the copying.

Returning to FIG. 2, the processor 11 determines whether the copy start button has been pressed while the screen shown in FIG. 3 is being displayed (ACT 204). When it is determined that the copy start button has not been pressed (N of ACT 204), the processor 11 repeats the same operation every predetermined period of time. When it is determined that the copy start button has been pressed (Y of ACT 204), the processor 11 acquires information on the number “n” of volumes of copy input from the input unit 17 (ACT 205). Next, the processor 11 acquires defined distribution information on the screen shown in FIG. 3 (ACT 206). Next, the processor 11 reads the manuscript set on the scanner 14 (ACT 207). The detailed scan operation of ACT 207 will be described later. In ACT 207, the processor 11 reads the manuscript and additionally reads the manuscript trace information given to the manuscript.

The processor 11 determines whether the copy authority is met after the scan operation of ACT 207 has been finished (ACT 208). In other words, ACT 208 as the determination unit determines whether the user is authorized to copy the manuscript based on the user information authorized in ACT 202 and the manuscript trace information read in ACT 207. When it is determined that the user is not authorized to copy the manuscript (N of ACT 208), the processor 11 issues an instruction of displaying an error message on the display 16 (ACT 209). The processor 11 issues an instruction of displaying the fact that the copy-instructed contents have been canceled when the error message has been issued. Then, the processor 11 terminates the operation.

When it is determined that the copy authority is met (Y of ACT 208), the processor 11 sets a variable as m=1 and initializes the variable “m” for copy operation (ACT 210). The variable “m” indicates the number of completed volumes of copy. The processor 11 instructs the printer 15 to copy with a new QR code (ACT 211). The copy operation with the new QR code will be described later in detail. The QR code contains therein the trace information itself or information on the trace information. In the present embodiment, both the trace information itself and the information on the trace information are defined as trace information. In ACT 211, new trace information readable in the scanner 14 is output in an image along with the manuscript read in the scanner 14.

When the copy operation with the new QR code is completed, the variable “m” indicating the number of completed volumes is incremented (ACT 212). The processor 11 determines whether the copying has been terminated (ACT 213). In other words, a determination is made as to whether the variable “m” indicating the number of completed volumes of copy coincides with the information on the number “n” of volumes of copy acquired in ACT 205. When it is determined that the copying has not been terminated (N of ACT 213), the processor 11 returns to ACT 210. When it is determined that the copying has been terminated (Y of ACT 213), the processor 11 updates the information in the tracing management DB 21 and the document management DB 22 (ACT 214).

Subsequently, the processor 11 determines whether the ledger is to be printed (ACT 215). The determination can be made by checking whether the management ledger output button shown in FIG. 3 has been pressed upon acquiring the distribution information in ACT 206. When it is determined that the ledger is to be printed (Y of ACT 215), the processor 11 instructs the printer 15 to print the ledger (ACT 216). When it is determined that the ledger is not to be printed (N of ACT 215), the processor 11 terminates the operation.

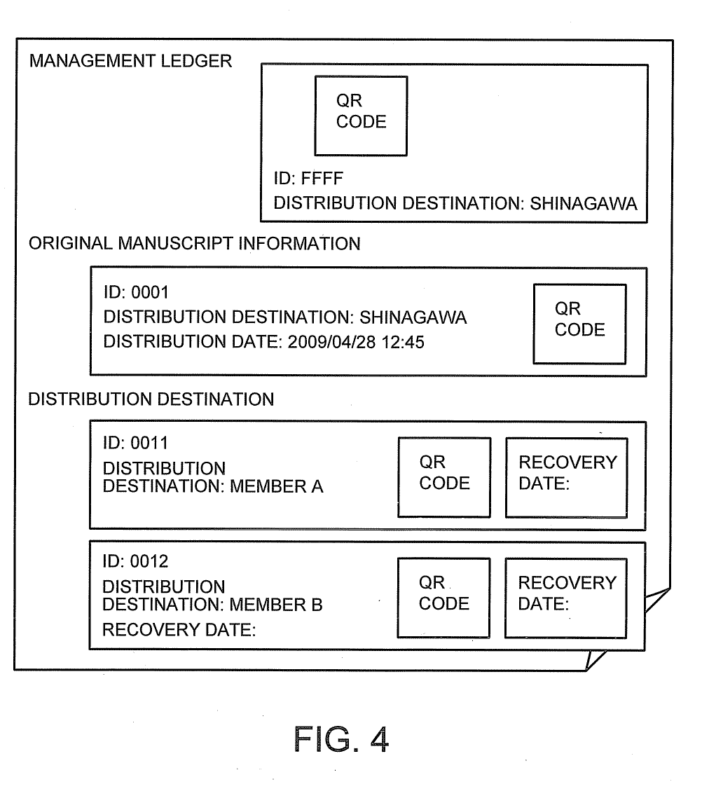

FIG. 4 shows an image of the printed ledger. The ledger displays therein the information on only one original manuscript and at least one distribution destination. The original manuscript information indicates the QR code containing an ID number indicating an identification as part of the trace information, a name of a distributor, that is, a person who has copied, a copy-instructed time/date as distribution time/date, and other trace information used for tracing. Each item of distribution destination information indicates an ID number indicating an identification as part of the trace information, a name of a person who has received the distribution, a QR code used for tracing, and a recovery date frame in which the recovery date can be written. In this example, multiple distribution destinations are present, the ID numbers of the original manuscript are different and the ID numbers of newly-distributed document are different. Thus, even when multiple copies are made, the distribution paths can be accurately traced.

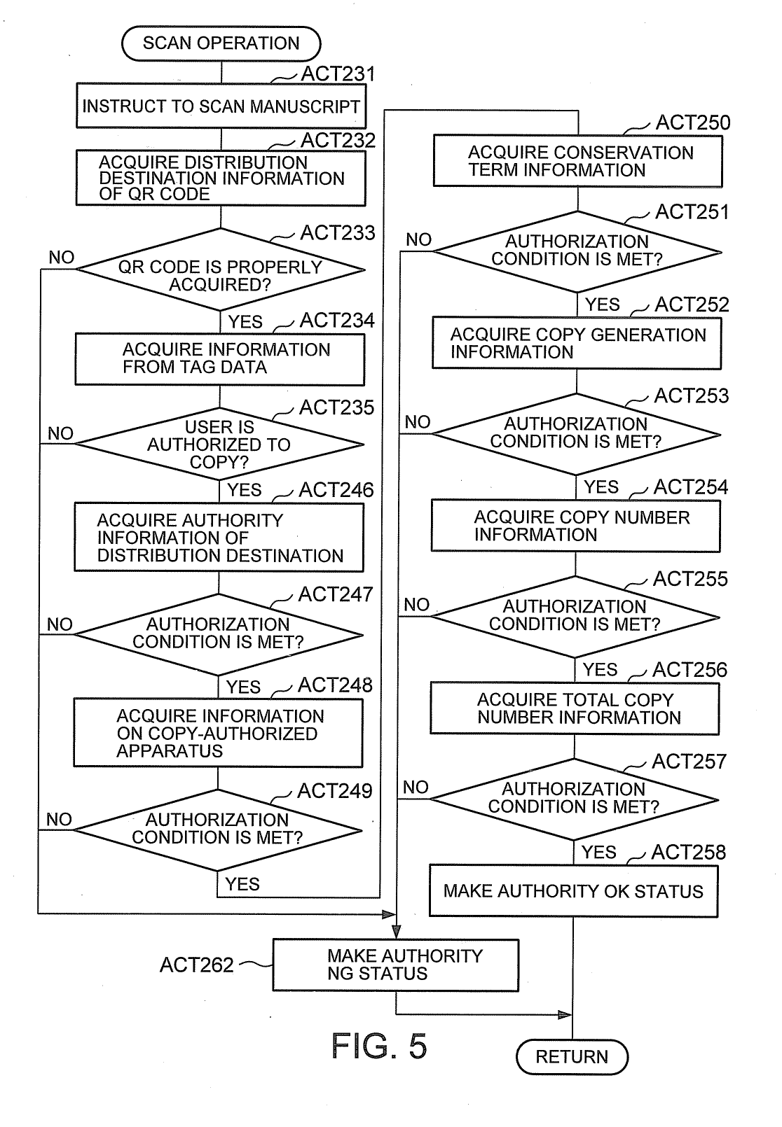

Next, the scan operation in ACT 207 will be described in detail using FIG. 5.

The processor 11 instructs the scanner 14 to scan the manuscript set in the scanner 14 (ACT 231). At this time, the trace information is recorded in a certain position of the manuscript and the identification information indicating the manuscript identification is contained in the trace information.

The processor 11 detects the QR code as the trace information from the image read in the scanner 14 and acquires the distribution destination information and the like (ACT 232). The processor 11 determines whether the QR code detected in ACT 232 can be properly acquired (ACT 233). When it is determined that the QR code has been properly acquired (Y of ACT 233), the processor 11 acquires user information from the tag data acquired at the time of the user authentication in ACT 202 (ACT 234).

The processor 11 compares the distribution destination information acquired in ACT 232 with the user information acquired in ACT 234 and determines whether both are the same (ACT 235). In other words, a determination is made as to whether the user is the person himself/herself that has received the manuscript.

When it is determined that both are the same (Y of ACT 235), the processor 11 acquires the authority information on the distribution destination acquired in ACT 206 (ACT 246). The processor 11 determines whether a person to which the copy is newly distributed meets a distribution authorization condition (ACT 247). When it is determined that the person to which the copy is newly distributed meets the distribution authorization condition (Y of ACT 247), the processor 11 acquires the information on the copy-authorized apparatus (ACT 248). The processor 11 determines whether the copying in the MFP meets the authorization condition (ACT 249). For example, when the document managing system is implemented in one MFP, the copy-unauthorized information is applied to the document printed in other MFP. When it is determined that the copying in the relevant MFP meets the condition (Y of ACT 249), the processor 11 acquires the conservation term information (ACT 250). In other words, a determination is made as to whether the manuscript to be copied is within the copy-authorized date.

The processor 11 determines whether the authorization condition of the conservation term information is met (ACT 251). When it is determined that the authorization condition of the conservation term information is met (Y of ACT 250), the processor 11 acquires copy generation information (ACT 252). In other words, a person who has received the manuscript is authorized to distribute its copies but the distributed copies are not authorized to be further copied. In some cases, the second generation copy may be permitted but the third generation copy may not be permitted. The copy generation information corresponding to the case is acquired.

The processor 11 determines whether the acquired copy generation information meets the authorization condition (ACT 253). When it is determined that the acquired copy generation information meets the authorization condition (Y of ACT 253), the processor 11 acquires copy number information (ACT 254). The processor 11 determines whether the acquired number of volumes of copy meets the authorization condition (ACT 255). When it is determined that the number of volumes of copy meets the authorization condition (Y of ACT 255), the processor 11 acquires the information on the total number of past volumes of copy (ACT 256).

The processor 11 determines whether the acquired total number of volumes of copy meets the authorization condition (ACT 257). In other words, the processor 11 determines whether the predetermined upper limit of the number of volumes of copy is exceeded when the total number of past volumes of copy is added with the number “n” of present volumes of copy. When it is determined that the total number meets the authorization condition (Y of ACT 257), the processor 11 stores the authority in the OK status (ACT 258).

On the other hand, the processor 11 stores the authority in the NG status (ACT 262) when the QR code cannot be properly acquired (N of ACT 233), when it is not determined that the user and a person who has received the distributed copy are the same (N of ACT 235), when a person to which the copy is newly distributed does not meet the distribution authorized condition (N of ACT 247), when it is determined that the copying in the MFP does not meet the authorization condition (N of ACT 249), when it is determined that the conservation term information does not meet the authorization condition (N of ACT 251), when it is determined that the copy generation information does not meet the authorization condition (N of ACT 253), when it is determined that the number of volumes of copy does not meet the authorization condition (N of ACT 255), and when it is determined that the total number of volumes of copy does not meet the authorization condition (N of ACT 257).

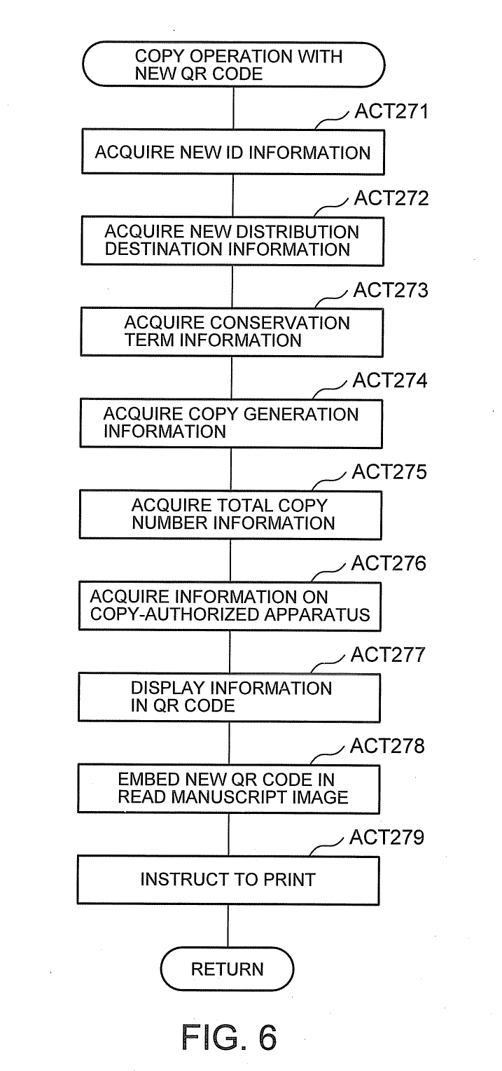

The copy operation with a new QR code in ACT 211 will now be described in detail using FIG. 6.

The processor 11 acquires new ID information (ACT 271). A new ID number (identification number) which has not been given in the past is given to the new ID at this time. When multiple volumes of copy are present, the ID numbers are created such that the copied documents are different. For example, the present variable “m” may be added to the lower digit after the ID numbers are carried by a predetermined number of digits. The processor 11 acquires new distribution destinations based on the information acquired in ACT 206 (ACT 272).

The processor 11 acquires the conservation term information acquired from the QR code in ACT 250 (ACT 273). The processor 11 acquires new copy generation information based on the copy generation information acquired from the QR code in ACT 252 (ACT 274). For example, if the first generation manuscript is copied, it may be changed to the second generation information or may be changed to the information on the number of remaining copy-enable generations. Next, the processor 11 acquires the information on the total number of volumes of copy (ACT 275). In other words, the present number of volumes of copy is added to the value of the total number of past volumes. Next, the processor 11 acquires the information on the copy-authorized apparatus (ACT 276).

The processor 11 creates a new QR code based on the information acquired in ACT 271 to ACT 276 (ACT 277). The processor 11 embeds the QR code created in ACT 277 in the image part of the QR code at the time of reading for the image information read based on the instruction of ACT 231, and creates a new image (ACT 278). The processor 11 instructs the printer 15 to copy (print) the image having the new QR code embedded (ACT 279).

In the present embodiment, the explanation has been made on the assumption that all the items of trace information from the internal database of the MFP 1 are acquired from the QR code. However, the preset invention is not limited thereto, and the trace information may be acquired from the outside of the MFP 1 based on the QR code. Further, the explanation has been made using the QR code in order to acquire the trace information, but the present invention is not limited thereto, and any system may be employed such as OCR-enable characters, 1D barcode, 2D barcode containing color code, hidden-character print, usage of ultraviolet ink as long as the trace information can be read. The items on which a determination is made as to whether the authorization condition is met do not need to contain all the items explained in FIG. 5, and may be partially or additionally employed.

In ACT 201 according to the present embodiment, the processor 11 uses the tag reader to read the information in order to make user authentication. However, the authentication method is not limited thereto, and the processor may instruct to display the screen into which the password is input from the input unit 17. Further, the user authentication is not limited to any of the well-known user authentication methods.

When the authority is NG in ACT 208 according to the present embodiment, the processor instructs to display an error message and terminates the operation, but the operation is not limited thereto and the processing may return to ACT 207 after ACT 209.

When a cancel instruction is input and received from the input unit 17 during the copy operation with the new QR code in ACT 211, the processor 11 may issue an instruction of stopping the copy operation. In this case, the processor 11 may instruct the display 16 to display the fact that the copy operation has been cancelled. The cancel indication may be distinguished between for the distributors who have already finished the copying and for the distributors who have not finished the copying yet.

Further, the processor 11 may instruct the display 16 to display the fact that the copying is being performed during the copy operation added with the new QR code in ACT 211. At this time, the distributors who have already completed the copying and the distributors who have not completed the copying yet may be distinguished. Further, the displaying may be performed for recognizing for which distributor the copying is being performed. When the copy operation has been completed (Y of ACT 213), the processor 11 may instruct the display 16 as a confirmation screen to display the fact that the copying has been completed. The cancel screen, the ongoing copy screen and the confirmation screen may be displayed along with the ledger print items.

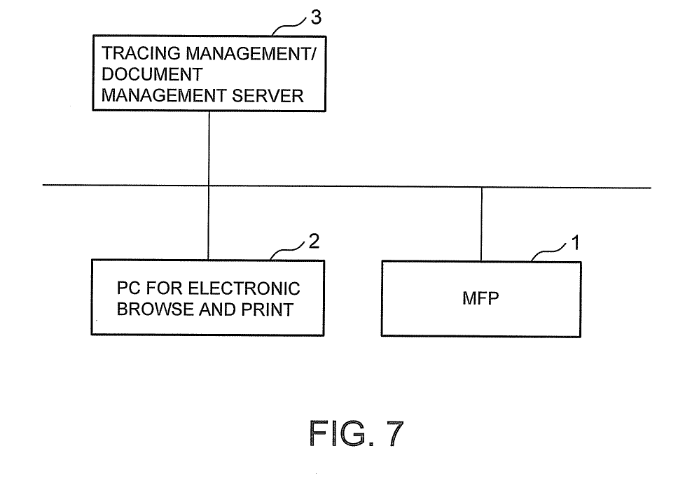

Next, a second embodiment will be described with reference to FIGS. 7 to 11.

A document managing system shown in FIG. 7 is implemented in multiple apparatuses via a network and is different from the first embodiment in that the document managing system is implemented only inside the MFP 1. The document managing system according to the second embodiment includes the MFP 1 for performing copy operation and an interface for exchanging data with the outside, in which a personal computer 2 for instructing to view computerized files or to print the computerized files and a server 3 having databases for tracing management and document management are connected via the network.

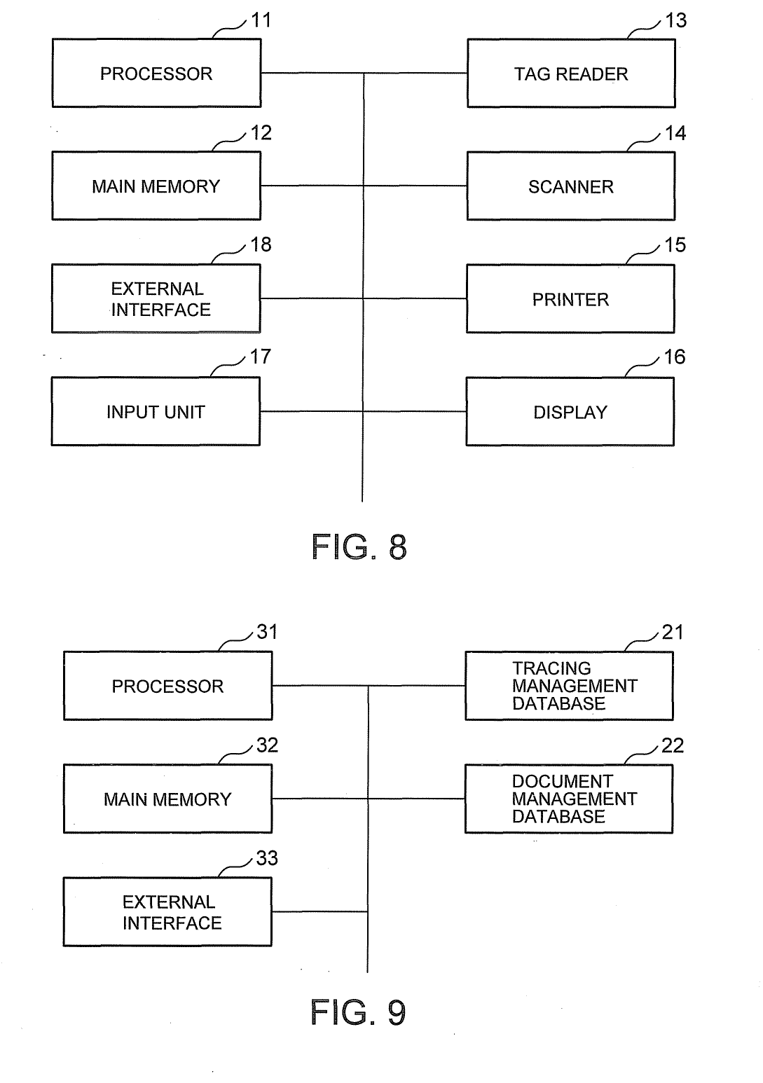

FIG. 8 is a block diagram of the MFP 1. The second embodiment is different from the first embodiment in that the tracing management DB 21 and the document management DB 22 for managing the documents are not provided. Others are the same as the first embodiment and thus the description thereof will be omitted.

FIG. 9 is a block diagram of the server 3. The server 3 includes a processor 31 for controlling the operations of an entire apparatus and a main. memory 32. The main memory 32 includes a memory for storing therein control programs of the apparatus and a memory for temporarily storing therein data when various operations are executed. The server 3 includes a tracing management DB 21 for storing therein information for managing the traces of the manuscript copied in the MFP 1 and a document management DB 22 for managing documents. Further, the information in the server 3 is connected with the MFP 1, the personal computer 2 and the like connected to the network via an external interface 33.

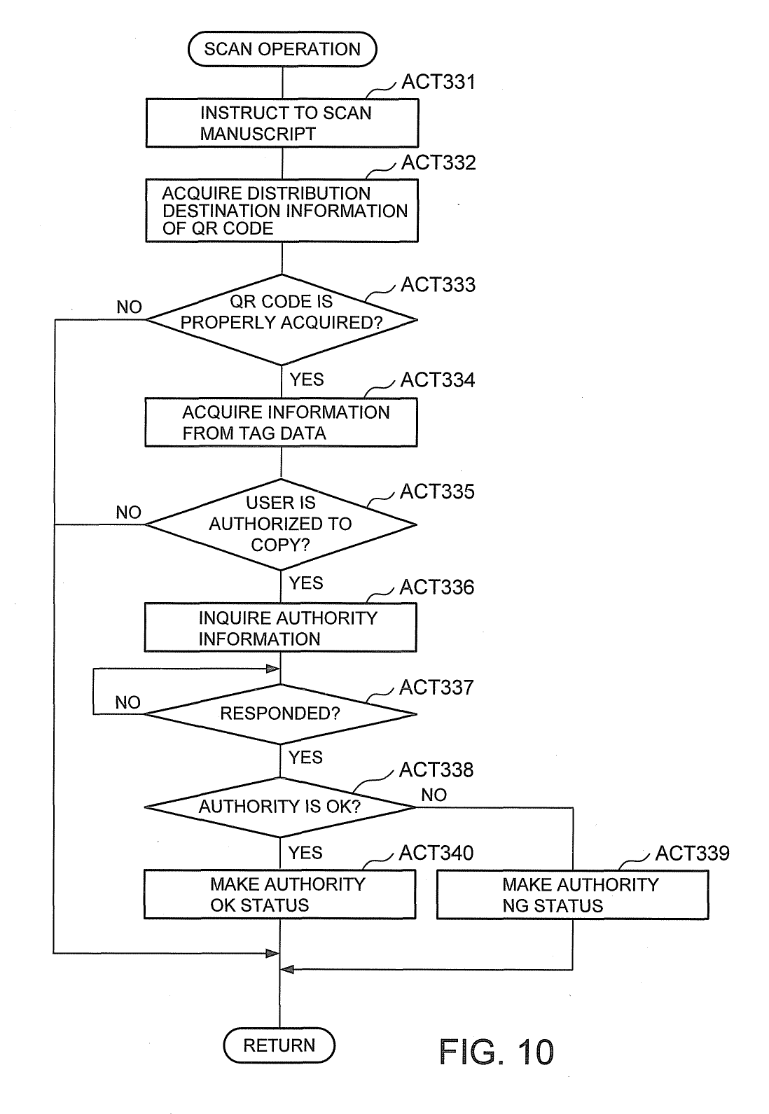

Next, the copy operation according to the second embodiment will be described. The explanation of the entire operations is similar to that in FIG. 2 according to the first embodiment and thus the explanation thereof will be omitted. A sub-flow of the scan operation (ACT 207) according to the second embodiment will now be described using the flowchart of FIG. 10.

In FIG. 10, ACT 331 to ACT 335 of the processor 31 are the same as the ACT 231 to ACT 235 of the processor 11 in FIG. 5 and thus the explanation thereof will be omitted. The processor 31 detects a code indicating an identification of the manuscript from the QR code acquired in ACT 332 and transmits the identification code to the server 3 via the external interface 18 and the network (ACT 336). After an inquiry in ACT 336, the processor 11 determines whether a response has been made to the inquiry in ACT 336 after a predetermined period of time via the external interface 18 (ACT 337).

When it is determined that no response has been made to the inquiry (N of ACT 337), the processor 11 determines whether a response has been made after a further predetermined period of time. When it is determined that a response has been made to the inquiry (Y of ACT 337), the processor 11 determines whether the authority for the instructed copying is OK, that is, the authority for the instructed copying is met (ACT 338). When it is determined that the authority for the instructed copying is met (Y of ACT 338), the processor 11 stores the authority for the instructed copying in the OK status (ACT 339) and terminates the operations of FIG. 9. On the other hand, when it is determined that the authority for the instructed copying is not met (N of ACT 338), the processor 11 stores the authority for the instructed copying in the NG status (ACT 340) and terminates the operations.

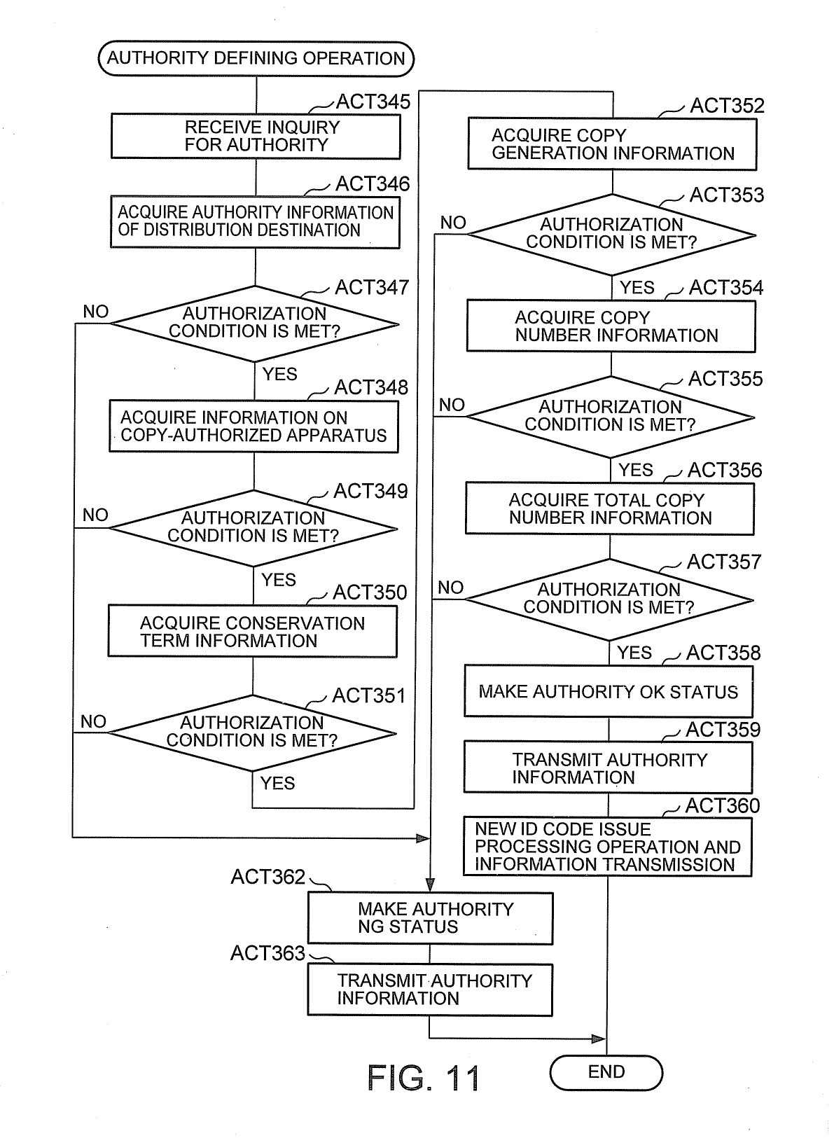

The authority defining operation of the server 3 will now be described using the flowchart of FIG. 11. The processor 31 receives an inquiry as to the authority for the copying from the MFP 1 in ACT 336 via the external interface 33 (ACT 345). ACT 346 to ACT 358 are the same as ACT 246 to ACT 258 shown in FIG. 2 in the operational contents except that the processor 11 in the MFP 1 is replaced with the processor 31 in the server 3, and thus the explanation thereof will be omitted.

After the completion of ACT 358, the processor 31 transmits the authority information (the fact that the authority is OK) to the MFP 1 via the external interface 33 (ACT 359). The processor 31 transmits a newly issued ID code and its information to the MFP 1 (ACT 360). When the same ID is used for copying in the MFP 1, the transmission is not performed. On the other hand, the processor 31 stores the authority in the NG status (ACT 362) when a person to whom a distribution is newly made does not meet the distribution authorization condition (N of ACT 347), when it is determined that the copying in the MFP does not meet the authorization condition (N of ACT 349), when it is determined that the authorization condition for the conservation term information is not met (N of ACT 351), when it is determined that the copy generation information does not meet the authorization condition (N of ACT 353), when it is determined that the number of volumes of copy does not meet the authorization condition (N of ACT 355) and when it is determined that the total number of volumes of copy does not meet the authorization condition (N of ACT 357). The processor 31 transmits the authority information (the fact that the authority is NG) to the MFP 1 via the external interface 33 (ACT 363).

The items with complementary explanations according to the first embodiment may be performed according to the second embodiment. In the second embodiment, the example in which multiple databases are provided in one server has been described, but one database may be provided in one server for operation. Further, one MFP including the image read function and the print mechanism is connected to the network according to the second embodiment, but the present invention is not limited thereto and a scanner and a printer may be connected over the network for implementing the present embodiment.

As shown in the first embodiment and the second embodiment, there is provided a document managing system capable of tracing the distribution destinations even when the copying is performed after the hard copies are distributed since an authority for new QR code or identification information is given to the manuscript every copy operation and the manuscript is output onto sheets.

What is claimed is:

1. A document managing system comprising:
a user authentication unit configured to acquire user information of a user;
a read unit configured to read a manuscript and read manuscript trace information given to the manuscript;
a determination unit configured to determine, in case of copying the manuscript, whether the user is authorized to copy the manuscript based on the user information read in the user authentication unit and the manuscript trace information; and
an image output unit configured to, if the determination unit determines that the user is authorized to copy, output an image including new trace information readable in a read unit along with the manuscript read in the read unit.

2. The system according to claim 1, wherein the image output unit outputs different pieces of trace information if multiple volumes are copied at one time.

3. The system according to claim 2, wherein the different pieces of trace information have different identification numbers.

4. The system according to claim 3, wherein the image output unit overwrites new trace information output in an image on the trace information read in the read unit.

5. The system according to claim 2, wherein the trace information includes information concerning the authorized to copy for subsequent following generations.

6. The system according to claim 2, wherein the trace information includes information concerning a conservation term.

7. The system according to claim 2, wherein the trace information includes information concerning copy number.

8. The system according to claim 2, wherein the trace information includes information concerning total number of volumes of copy.

9. The system according to claim 2, wherein the image output unit overwrites new trace information output in an image on the trace information read in the read unit.

10. The system according to claim 1, wherein the trace information includes information concerning the authorized to copy for subsequent following generations.

11. The system according to claim 1, wherein the trace information includes information concerning total number of volumes of copy.

12. The system according to claim 1, wherein the image output unit overwrites new trace information output in an image on the trace information read in the read unit.

13. A document managing system comprising:
a user authentication reader that acquires user information of a user;
a manuscript reader that reads a manuscript and reads manuscript trace information given to the manuscript;
a controller that determines, in case of copying the manuscript, whether the user is authorized to copy the manuscript based on the user information read by the user authentication reader and the manuscript trace information; and
a printer that, if the controller determines that the user is authorized to copy, outputs an image including new trace information readable by a manuscript reader along with the manuscript read by the manuscript reader.

14. The system according to claim 13, wherein the printer outputs different pieces of trace information if multiple volumes are copied at one time.

15. The system according to claim 14, wherein the printer overwrites new trace information output in an image on the trace information read by the manuscript reader.

16. A document managing method comprising:
acquiring user information of a user;
reading a manuscript and reading manuscript trace information given to the manuscript;
determining, in case of copying the manuscript, whether the user is authorized to copy the manuscript based on the user information and the manuscript trace information; and
outputting an image including new trace information readable along with the read manuscript if it is determined that the user is authorized to copy.

17. The method according to claim 16, wherein the image outputting outputs different pieces of trace information if multiple volumes are copied at one time.

18. The method according to claim 16, wherein the different pieces of trace information have different identification numbers.

19. The method according to claim 7, wherein the image outputting overwrites new trace information output in an image on the trace information read.
